(19) United States
(12) Patent Application Publication
(10) Pub. No.: US 2002/0158818 A1
(43) Pub. Date: Oct. 31, 2002

(54) Lighting system simulating sunrise and sunset

(76) Inventor: Shi Youl Noh, Seoul (KR)

Correspondence Address: Cooper & Dunham LLP, 1185 Avenue of the Americas, New York, NY, 10036, US

(21) Appl. No.: 09/842,460

(22) Filed: Apr. 26, 2001

(51) Int. Cl. G09G 3/18

(52) U.S. Cl. 345/50

(57) ABSTRACT

Disclosed is a lighting system simulating sunrise and sunset, which can control a desired luminous intensity and color temperature to be turned on or off on a wanted time in an easier manner by employing a remote controller for transferring a remote signal, a controller for controlling the on and off condition of the luminous intensity and color temperature of a stabilizer based on the remote signal transferred from the remote controller and a self stacked signal, and a liquid crystal display device for displaying the luminous intensity and the color temperature on a graphic screen to easily identify the result of the aforementioned control.

### BACKGROUND OF THE INVENTION

1. Field of the Invention

The present invention relates generally to a lighting system simulating sunrise and sunset, and more particularly, to a lighting system simulating sunrise and sunset, which can control a desired luminous intensity and color temperature to be turned on or off on a wanted time in an easier manner by employing a controller for controlling the on and off condition of a stabilizer and the luminous intensity and color temperature of a lamp, and a liquid crystal display (LCD) device for easily identifying the result of the aforementioned control.

2. Description of the Related Art

In general, a cable-connected indoor lighting system of the conventional art is operated to be on or off by an additional switch protectively installed to an indoor wall or the like. The conventional indoor lighting system operated in this way, however, arises the problem that a user must goes himself/herself to the place where the switch is installed to turn the lighting system on or off.

Therefore, a recent attempt has been directed to suggest an indoor lighting system including a remote controller for a wireless control thereof. The indoor lighting system including the remote controller comprises a body, a lamp section having a fluorescent light bulb and a plurality of incandescent light bulbs, and a remote control receiving section disposed in one end of the body. The remote controller further includes a key operation section for operating the incandescent light bulbs and a remote control transmitting section for transmitting data to the remote control receiving section.

According to the indoor lighting system of this constitution, a user is able to control the indoor lighting system in an easy way by operating the remote controller with no use of moving to the place where the switch is installed. Also, the power on and off as well as brightness of the indoor lighting system can be controlled by means of the remote controller, thereby serving to produce various indoor lighting conditions according to illuminance variation.

The conventional indoor lighting system including the remote controller has a shortcoming, though, that if the user wants to turn on the lighting system, which is in an off state, at night, he/her has to turn on the additionally installed switch to find the remote controller, and then operates the key operation section in the remote controller to control the lighting system again. Thus, the remote controller loses its operation convenience at night, and instead the double work is needed for the operation of the lighting system in that the switch is first turned on to operate the remote controller. Further, the remote controller may be connected to one or more lighting systems which are accordingly operated at the same time, irrespective of their numbers, but unable to be operated on an individual basis, incurring great power rates. Besides, under construction, constructional facilities, i.e., molding flask, etc, are susceptible to be damaged by an electric work, deteriorating strength thereof and prolonging the construction period. Provided that the interior of a house is to be altered, the interior is considerably affected by electric wiring, plumbing, etc.

The Korean utility model assigned issue number 20-146642 suggests a lighting system, which comprises a receiving section for receiving an optical signal transmitted from a remote controller and inputting the same into a central processing unit (CPU) to control an electric lamp as a load of an outputting section by comparing and analyzing the input signal, a switch section for controlling the loaded electric lamp by hand, a memory section for storing a type and a period of a signal inputted from a selection key, which is of low frequency in use and thus rarely affects on a function of a pertinent product, such as, a numerical key 0, a skip key, a time display key, or the like on a TV or a VTR remote controller, and an oscillating section and a power section disposed in one end of the CPU for operating the CPU.

The Korean utility model assigned issue number 20-146741 suggests a lighting system employing a conventional remote controller for controlling an electric application, for example, a lighting system, turned on or off in a remote place by storing uniquely identified data of the remote controller and each data corresponding to each key in a receiving circuit.

The Korean utility model assigned issue number 20-131266 suggests a lighting system comprising an illumination sensor for sensing an indoor luminous intensity, a contact sensor operated by a user's touch, and a controller for controlling a remote controller to render the lighting system turned on when the indoor luminous intensity is less than a predetermined value and the contact sensor indicates that the user wants to use the remote controller, whereby the lighting system is easily powered on even in a dark place around.

The aforementioned devices pose the problems as follows. Ceilings, walls, floors, etc. of constructions are electrically wired and pipe-arranged, thereby elongating the construction period, damaging the constructions, deteriorating the strength of the constructions, and invoking bottlenecks caused by the electric installation in case of interior alteration.

### SUMMARY OF THE INVENTION

It is, therefore, an object of the present invention to provide a lighting system simulating sunrise and sunset, which can produce a natural lighting condition, such as sunrise and sunset, etc., by controlling a power on/off of a stabilizer and a desired illumination and a color temperature of a lamp on a wanted time in an easier manner by identifying the result of the control through a graphic liquid crystal display (LCD) device.

To achieve the above object, there is provided the lighting system simulating the sunrise and sunset, comprising: a remote controller for transmitting a remote signal; a mi-com main controller for controlling an input signal thereof and the remote signal from the remote controller; a graphic LCD device for graphically displaying a luminous intensity and a color temperature controlled by the mi-com main controller; a power supplier including a relay for supplying a D.C. power to the mi-com main controller and turning on or off an A.C. power supply under the control of the mi-com main controller; a plurality of illuminators for illuminating at the luminous intensity and color temperature controlled by the remote signal of the remote controller and the input signal of the mi-com main controller; an auxiliary remote controller for transmitting a remote signal thereof; a mi-com auxiliary controller for controlling an input signal thereof and the remote signal of the auxiliary remote controller; an auxiliary graphic LCD device for graphically displaying a luminous intensity and color temperature controlled by the mi-com auxiliary controller; an auxiliary power supplier including a relay for supplying a D.C. power to the mi-com auxiliary controller and turning on or off an A.C. power supply under the control of the mi-com auxiliary controller; and a plurality of auxiliary illuminators for illuminating at the luminous intensity and color temperature controlled by the remote signal of the auxiliary remote controller and the input signal of the mi-com auxiliary controller.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a lighting system simulating sunrise and sunset according to the present invention;

FIG. 2 is a flow chart illustrating a main power supply according to the present invention;

FIG. 3 is a flow chart illustrating a power supply of a mi-com main controller according to the present invention;

FIG. 4 is a flow chart illustrating a regulation of a luminous intensity and a color temperature according to the present invention;

FIG. 5 is flow chart illustrating a state identification of an auxiliary controller according to the present invention; and

FIG. 6 is a flow chart illustrating a pre-set illumination according to the present invention;

FIG. 7 to FIG. 12 are flow charts illustrating a scheduler according to the present invention;

FIG. 13 is a flow chart illustrating a reserved execution of the sunrise and sunset according to the present invention;

FIG. 14 is a flow chart illustrating other reserved executions according to the present invention;

FIG. 15 is a flow chart illustrating a sunrise function according to the present invention;

FIG. 16 is a flow chart illustrating a sunset function according to the present invention; and

FIG. 17 is a flow chart illustrating a sleep function according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

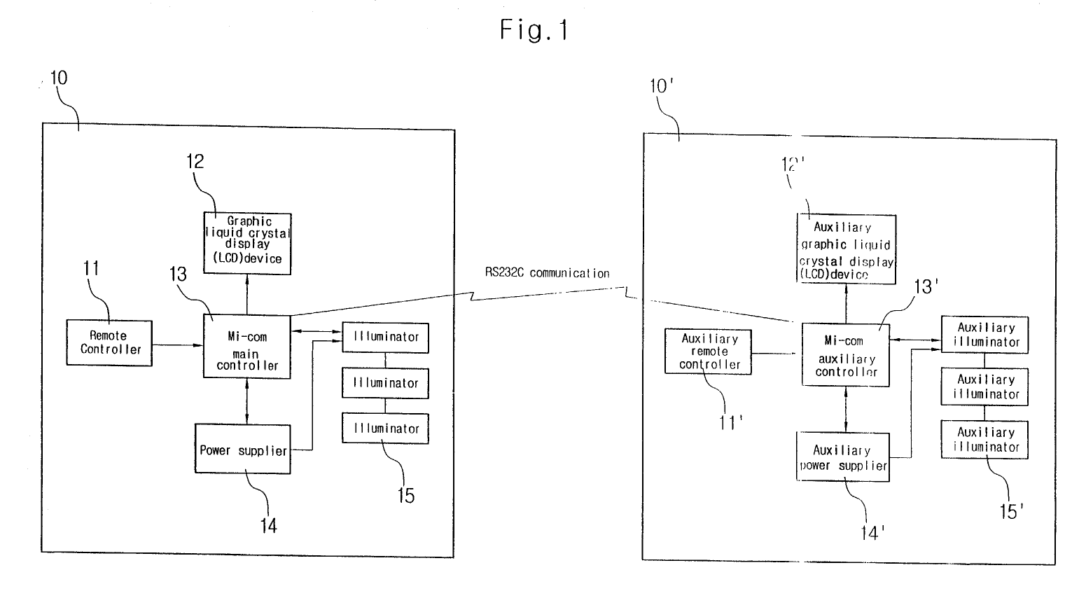

FIG. 1 is a block diagram illustrating a lighting system simulating sunrise and sunset according to the present invention.

Referring to FIG. 1, the lighting system simulating the sunrise and sunset according to the present invention comprises: a main controller 10 including a remote controller 11 for transmitting a remote signal, a mi-com main controller 13 for controlling an input signal thereof and the remote signal from the remote controller 11, a graphic liquid crystal display (LCD) device 12 for graphically displaying a luminous intensity and a color temperature controlled by the mi-com main controller 13, a power supplier 14 having a relay for supplying a D.C. power to the mi-com main controller 13 and turning on or off an A.C. power supply under the control of the mi-com main controller 13, and a plurality of illuminators 15 connected to the mi-com main controller 13 for illuminating at the luminous intensity and color temperature controlled by the remote signal of the remote controller 11 and the input signal of the mi-com main controller 13; and an auxiliary controller 10′ including an auxiliary remote controller 11′ far distanced from the main controller 10 for transmitting a remote signal, a mi-com auxiliary controller 13′ for controlling the input signal thereof and the remote signal of the auxiliary remote controller 11′, an auxiliary graphic LCD device 12′ for graphically displaying a luminous intensity and color temperature controlled by the mi-com auxiliary controller 13′, an auxiliary power supplier 14′ having a relay for supplying a D.C. power to the mi-com auxiliary controller 13′ and turning on or off an A.C. power supply under the control of the mi-com auxiliary controller 13′, and a plurality of auxiliary illuminators 15′ connected to the mi-com auxiliary controller 13′ for illuminating at the luminous intensity and color temperature controlled by the remote signal of the auxiliary remote controller 11′ and the input signal of the mi-com auxiliary controller 13′. The mi-com main controller 13 is able to easily control data throughout 24 hours by setting required data on a necessary point of time at specific intervals (e.g., 5 minutes), and identify the overall 24-hour reservations at one sight by using the graphic LCD device 12.

The auxiliary illuminators 15′ connected to the mi-com auxiliary controller 13′ which is connected to the mi-com main controller 13 of the main controller 10 in RS232C communication manner are controlled to be turned on or off at the pertinent luminous intensity and color temperature, and interlocked to the on/off operation of the main controller so as to be simultaneously turned on or off.

After a user sets a reserved time and a sunrise period, the lighting system is turned on at minimum luminous intensity and color temperature values before the pre-set time, the minimum luminous intensity and color temperature values increasing by steps for the pre-set period and corresponding to the luminous intensity and color temperature of the sunrise time at the end of the pre-set period, later keeping the values on.

After the user sets a reserved time and a sunset period, the lighting system is turned on before the pre-set time at certain luminous intensity and color temperature values, the luminous intensity and color temperature values decreasing by specific steps for the pre-set period and the lighting system turned off at the end of the pre-set period, later keeping final values on.

After the user sets each familiar luminous intensity and color temperature value corresponding to a pertinent key, i.e., morning illumination, afternoon illumination, night illumination, etc., the lighting system irradiates light at the pre-set luminous intensity and color temperature corresponding to the each key upon receipt of the key input. The pre-set luminous intensity and color temperature are initially set to be a default value but may be re-set depending on the user's request.

If the user inputs a function key for simulating sunset in a one-touch manner, current luminous intensity and color temperature values are turned into initial luminous intensity and color temperature values in a very short time (in several seconds), which decrease by specific steps throughout 600 seconds to the point when the power supply to the lighting system is turned off at the end of the pre-set period, later keeping the final values on.

The on-off action of the power supply, and the luminous intensity and color temperature may be locked by selecting either the main controller 10 or the auxiliary controller 10′ inter-connected with each other. The locked condition is cancelled when the auxiliary controller 10′ requests the main controller 10 for the lock cancellation by inputting a specific key on the auxiliary controller 10′, which is capable of self-setting later.

The mi-com main controller displays a variable range of the luminous intensity and color temperature and also the current state within a pre-displayed range when the user inputs a pertinent function key disposed in the remote controller 11 or in the mi-com main controller 13 on the graphic LCD device 12, to set an illumination state desired by the user in a faster way.

A filament of the illuminators 15 is pre-heated about 5 minutes before the power-on of the illuminators 15 by applying voltage to the filaments to allow the illumination to be smoothly variable at a low luminous intensity when the user sets the reserved time and sunset period.

The luminous intensity and color temperature repeatedly go up and down at a specific cycle but perform a sort of wave function where the values have a pause at the lowest point and at the highest point for about 2 seconds.

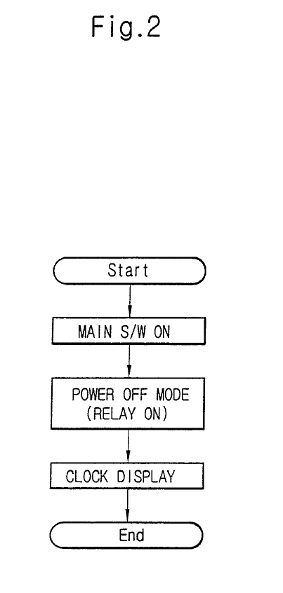

FIG. 2 is a flow chart illustrating a main power supply according to the present invention.

Referring to FIG. 2, a main switch on the main controller 10 and the relay on the auxiliary controller 10′ are operated to display a clock.

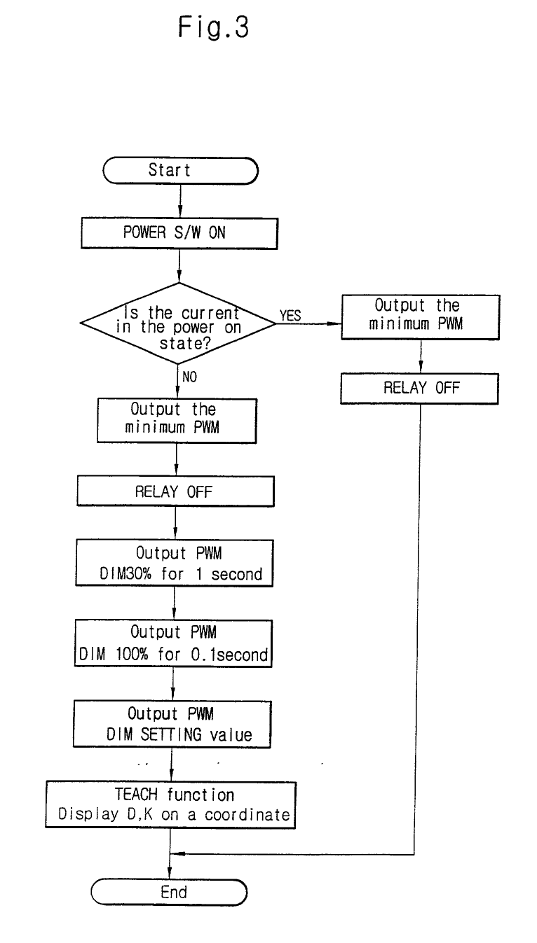

FIG. 3 is a flow chart illustrating a power supply of the mi-com main controller according to the present invention.

Referring to FIG. 3, a power switch is operated to determine whether or not the power supply is in the on state. In the negative, the minimum PWM is outputted and the relay is turned off. PWM of luminous intensity rate 30% is outputted for 1 second, and PWM of luminous intensity rate 100% is outputted for 0.1 seconds. Thereafter, PWM of the pre-set luminous intensity is outputted to perform a teach function where the luminous intensity and color temperature are displayed on a coordinate. If the power supply is in the on state, however, the minimum TWM is outputted and the relay is turned on, making the lighting system off.

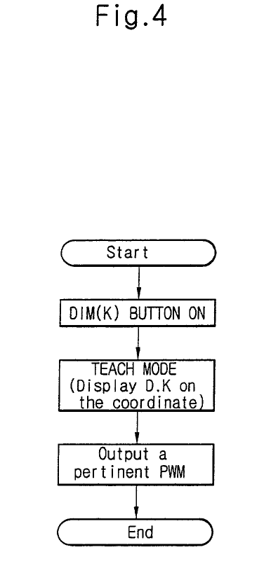

FIG. 4 is a flow chart illustrating a regulation of the luminous intensity and color temperature according to the present invention.

Referring to FIG. 4, a button for regulating the luminous intensity and color temperature is turned on, and then the teach mode is proceeded to display the luminous intensity and color temperature on the coordinate, outputting the pertinent PWM value.

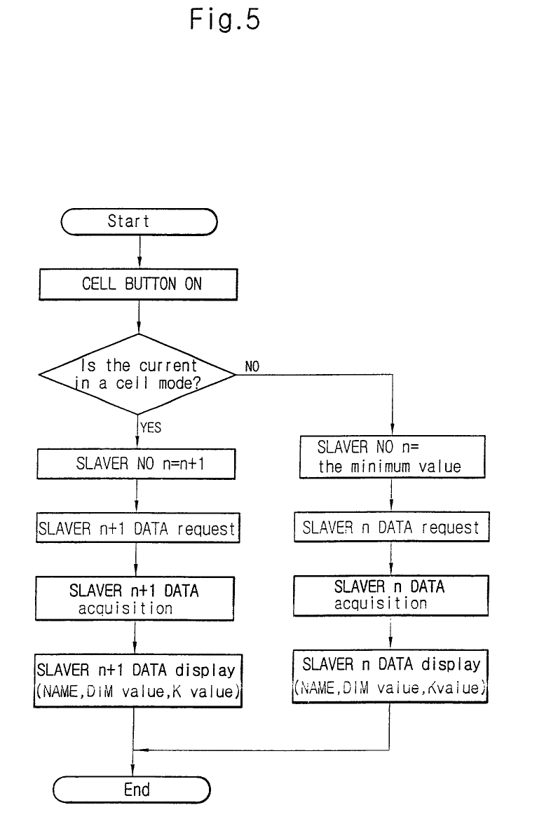

FIG. 5 is a flow chart illustrating a state identification of the auxiliary controller according to the present invention.

Referring to FIG. 5, a cell button is turned on to determine whether or not the current state is in a cell mode. In the affirmative, the auxiliary controller n+1 data are displayed, i.e., auxiliary controller NO n=n+1, auxiliary controller n+1 data request, auxiliary controller n+1 data acquisition, name, luminous intensity value, and color temperature value. If the current state is not in the cell mode, in the meantime, the auxiliary controller 10′ n data are displayed i.e., auxiliary controller 10′ NO n=minimum value, auxiliary controller 10′ n data request, auxiliary controller 10′ n data acquisition, name, luminous intensity value, and color temperature value.

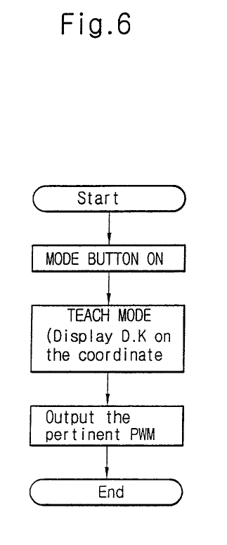

FIG. 6 is a flow chart illustrating a pre-set illumination according to the present invention.

Referring to FIG. 6, if a mode button is turned on, the teach mode is proceeded to display the luminous intensity and color temperature on the coordinate, outputting the pertinent PWM value.

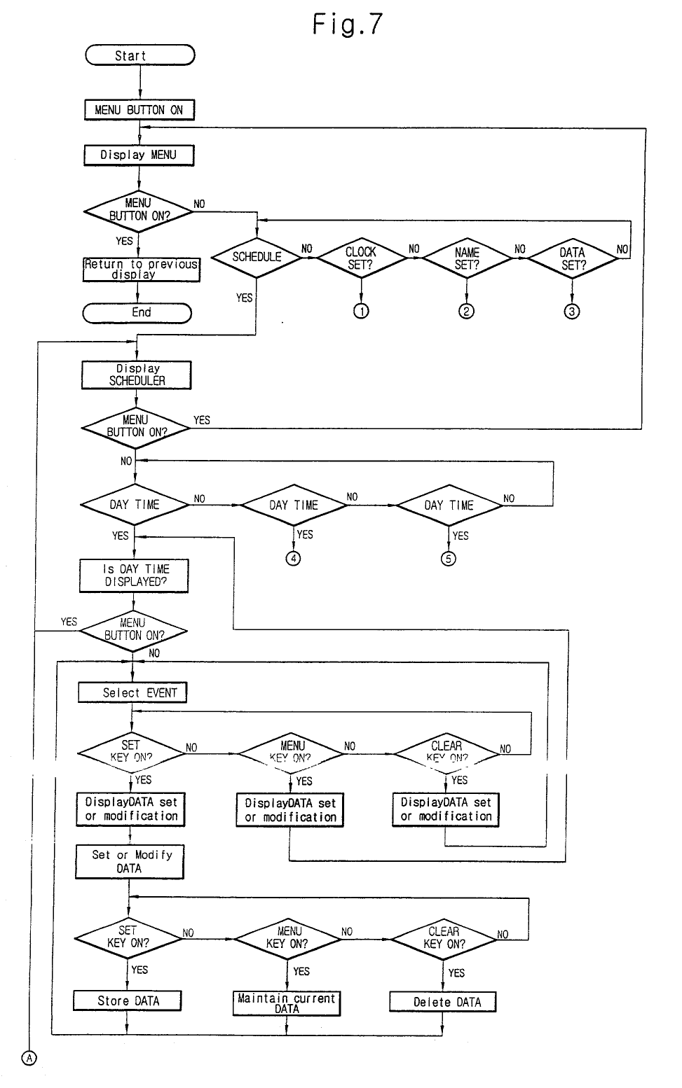

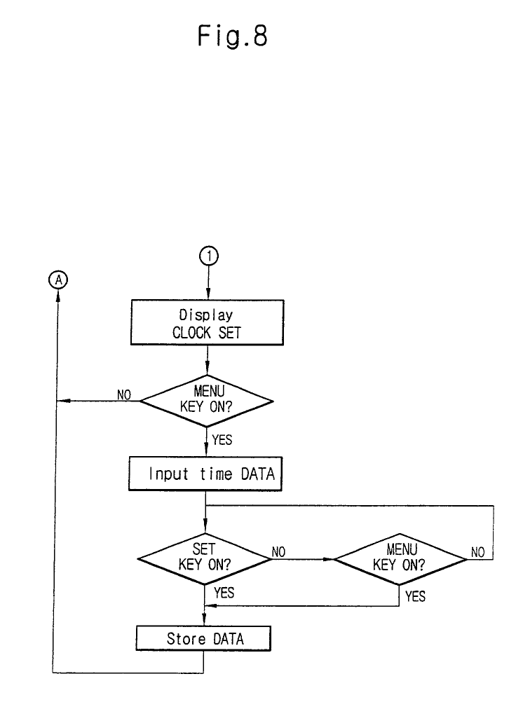

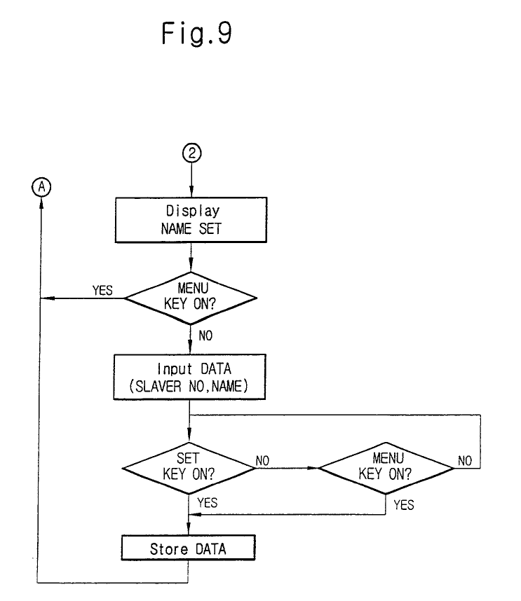

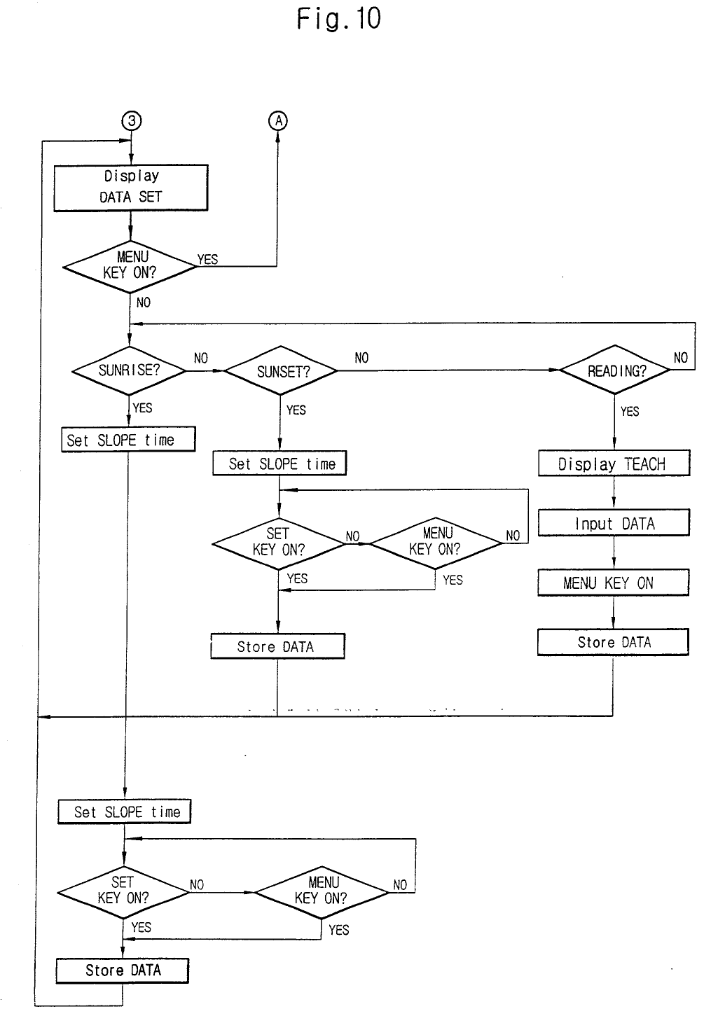

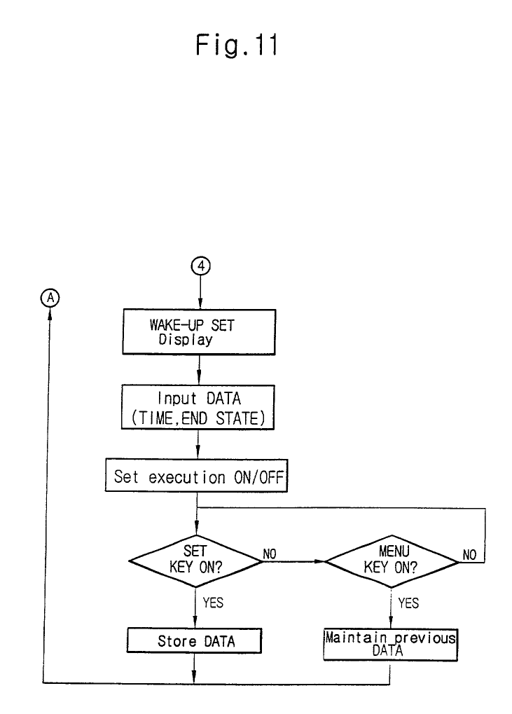

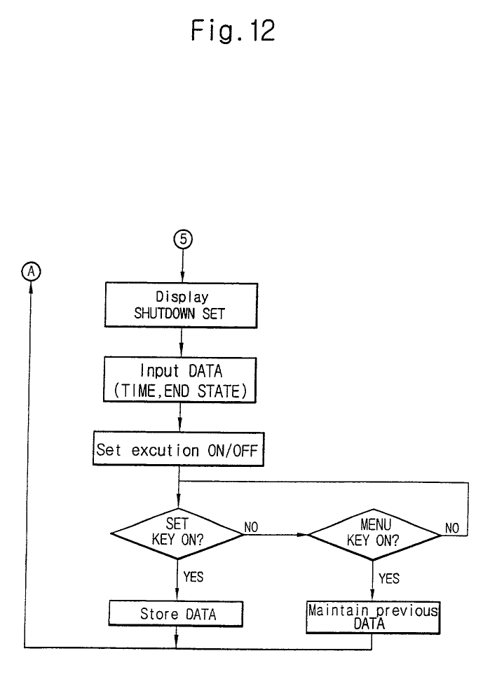

FIG. 7 to FIG. 12 are flow charts illustrating a scheduler according to the present invention.

Referring to FIG. 7 to FIG. 12, a menu button is turned on to display a menu on a screen. If the menu button is determined to be in the on state, it is returned to a previous display step. If the menu button is determined to be in the off state, it is determined whether or not a schedule is set to proceed a scheduler display. If the menu button is determined again to be in the off state, it is determined whether or not a day time exists to proceed a day time display. If the menu button is determined again to be in the on state, it is returned to the scheduler display step. If the menu button is determined to be in the off state, a set key is determined to be in the on state through an event selection step. If the set key is determined to be in the on state, a data set or a data modification are displayed to set or modify data. Further, if the set key is determined to be in the on state, the data are stored. In the step of determining whether or not the day time exists, if not, it is determined whether or not a get-up time is set. If the get-up setting is displayed, data of the get-up setting time and a state at the end thereof are inputted. An execution on/off is set to determine whether or not the setting key is in the on state. In the affirmative, the data are stored and the step of determining whether or not the menu button is in the on state is re-proceed. In the step of determining whether or not the get-up time is set, it is determined whether or not a stop is set. If so, the data of the stop setting time and a state at the end thereof are inputted. An execution on/off is set to determine whether or not the setting key is in the on state. In the affirmative, the data are stored, whereas in the negative, it is determined whether or not the menu key is in the on state. If so, the previous data are maintained and it is returned to the step of determining whether or not the menu button is in the on state. In the step of determining whether or not the setting key is in the on state, if the setting key is not in the on state, it is determined whether or not the menu key is in the on state. In the affirmative, the current data are maintained and then the step of determining whether or not the menu button is in the on the state is re-proceeded. But, if the menu key is not in the on state, it is determined whether or not a clear key is in the on state. If so, the data are deleted and then it is returned to the step of determining whether or not the menu button is in the on state. If the clear key is not in the on state, it is returned to the step of determining whether or not the setting key is in the on state. In the step of determining whether or not the scheduler exists, in the negative, it is determined whether or not a clock is set. If a clock setting is displayed, it is determined whether or not the menu key is in the on state to input time data and also it is determined whether or not the setting key is in the on state to store the data, thereafter returning to the step of determining whether or not the menu button is in the on state. In the step of determining whether or not the menu key is in the on state, if it does not, the step of determining whether or not the menu button is in the on state is re-proceeded. In the step of determining whether or not the setting key is in the on state, if not wanted, it is determined whether or not the menu key is in the on state, returning to the step of determining whether or not the setting key is in the on state. In the step of determining whether or not the clock is set, if not wanted, a step of determining whether or not the name is set is proceeded. If wanted, a name setting is displayed to determine whether or not the menu key is in the on state. In the affirmative, the step of determining whether or not the menu key is in the on state is re-proceeded. If the menu key is not wanted to be turned on, the number and name of the auxiliary controller 10′ are inputted to return to the step determining whether or not the setting key is in the on state. Then, the data are stored to return to the step of determining whether or not the menu key is in the on state. If the setting key is not wanted to be turned on, it is determined whether or not the menu key is in the on state to return to the step of determining whether or not the setting key is in the on state. In the step of determining whether or not the menu key is in the on state, if the menu key is to be turned on, the step of determining whether or not the menu button is in the on state is re-proceeded. In the step of determining whether or not the name is set, if the name is not wanted to be set, the step of determining whether or not the data are set is re-proceeded to display the data setting. If the menu key is not wanted to turned on, it is determined whether or not the sunrise is set. If wanted, the sunrise setting is displayed to set a slope time and it is determined whether or not the setting key is in the on state to store the data, thereafter returning to the step of displaying the data set. In the step of determining whether or not the sunrise is set, if not wanted, a step of determining whether or not the sunset is set is proceeded. If wanted, a sunset setting is displayed to set a slope time and it is determined whether or not the setting key is in the on state to store the data, thereafter returning to the step of displaying the data set. In the step of determining whether or not the sunset is set, if not wanted, a step of determining whether or not a reading exists. If wanted, it is turned to a teach screen where the data are inputted, the menu key is turned on, and the data are stored, thereafter returning to the step of displaying the data set.

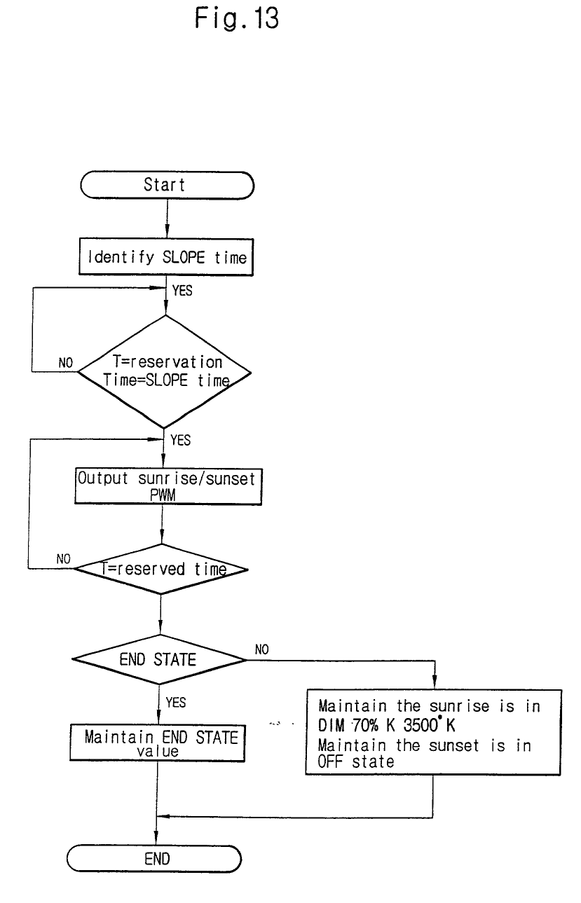

FIG. 13 is a flow chart illustrating a reserved execution of the sunrise and sunset according to the present invention.

Referring to FIG. 13, after identifying the slope time, it is determined whether or not the time, the reserved time and the slop time are identical to one another to output sunrise/sun PWM. Then, it is determined whether or not the time is equal to the reserved time and also determined whether or not the end state thereof exists to maintain the end state value, or 3500° K., a luminous intensity rate 70% of the sunrise time and the off state of the sunset time.

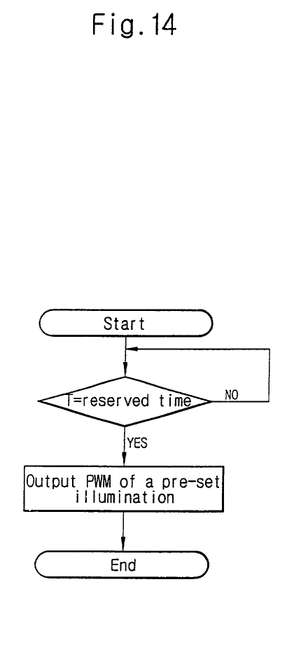

FIG. 14 is a flow chart illustrating other reserved executions according to the present invention.

Referring to FIG. 14, it is determined whether or not the time is equal to the reserved time. In the affirmative, PWM of the pre-set illumination is outputted.

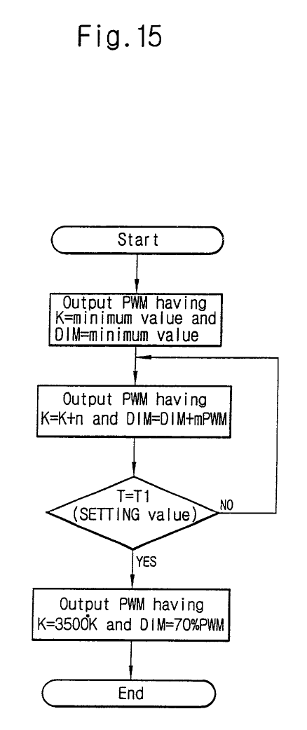

FIG. 15 is a flow chart illustrating a sunrise function according to the present invention.

Referring to FIG. 15, the minimum PWM of the luminous intensity and color temperature is outputted and PWM having K=K+n and DIM=DIM+m is also outputted to determine whether or not the set value is T=T1. If so, PWM having 3500° K. and luminous intensity 70% is outputted.

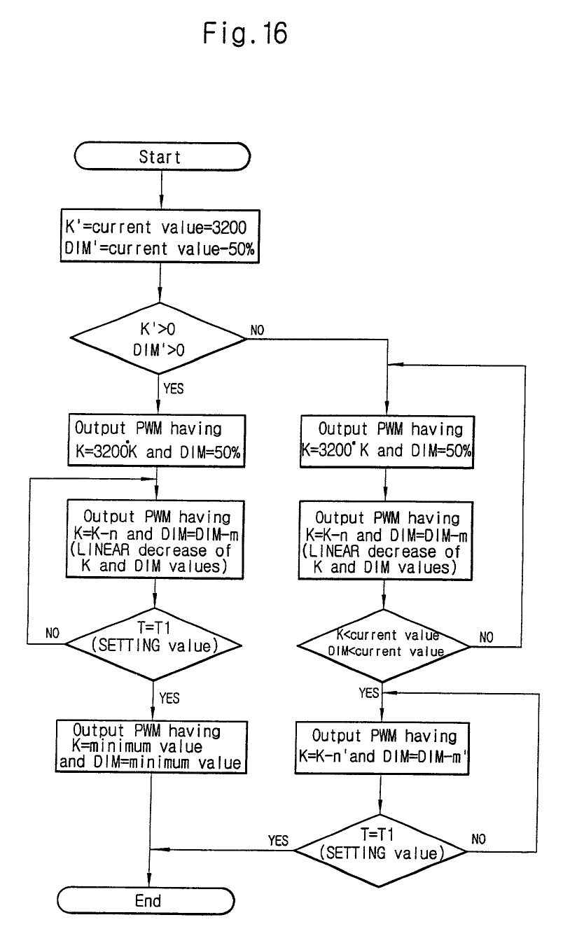

FIG. 16 is a flow chart illustrating a sunset function according to the present invention.

Referring to FIG. 16, it is determined whether or not it is K′>0 and DIM′>0 through a step of setting K′=current value−3200, and DIM′=current value−50%. In the affirmative, PWM having K=3200° K. and DIM=50% is outputted and PWM of K=K−n and DIM=DIM−M is also outputted to determinine whether or not it is T=T1 If so, the minimum PWM of the luminous intensity and color temperature is outputted. In the step of determining whether or not it is K′>0 and DIM′>0, if they are less than 0, the current K′, DIM′ and PWM′ values are outputted, and PWM of K=3200−n and DIM=50−m is also outputted. If K and DIM are less than the current values, PWM of K=K−n′ and DIM=DIM−m′ is outputted to determine whether or not it is T=T1.

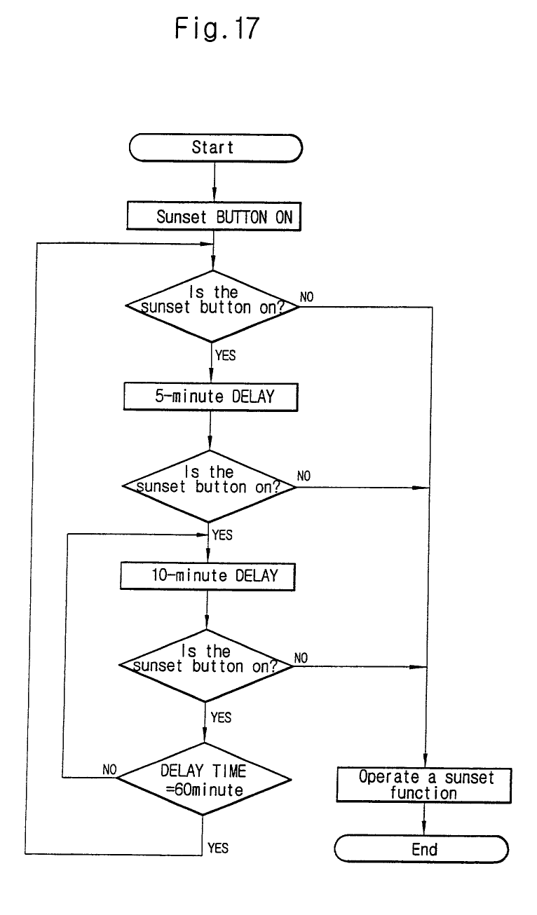

FIG. 17 is a flow chart illustrating a sleep function according to the present invention.

Referring to FIG. 17, the sunset button is turned on to determine whether or not the sunset button is turned on. If not wanted, a step of operating the sunset function is proceeded with after delaying 5 minutes to turn on the sunset button. If the sunset button is not wanted again to be turned on, the step of operating the sunset function is proceeded with after delaying 10 minutes. If the sunset button is wanted to be turned on, it is determined whether or not the delay time is 60 minutes. If it is not, it is returned to the step of delaying 10 minutes. If the delay time is 60 minutes, however, the step of determining whether or not the sunset button is turned on is re-proceeded.

As stated above, the lighting system simulating the sunrise and sunset according to the present invention has various advantages of producing a natural lighting condition, such as sunrise and sunset by means of the familiar luminous intensity and color temperature, and controlling the plurality of illuminators under the remote control by the remote controller or the control communication for valid period.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A lighting system simulating sunrise and sunset, comprising:
a remote controller for transmitting a remote signal;
a mi-com main controller for controlling an input signal thereof and said remote signal of said remote controller;
a graphic liquid crystal display (LCD) device for graphically displaying a luminous intensity and a color temperature controlled by said mi-com main controller;
a power supplier including a relay for supplying a D.C. power to said mi-com main controller and turning on or off an A.C. power supply under the control of said mi-com main controller;
a plurality of illuminators for illuminating at said luminous intensity and color temperature controlled by said remote signal of the remote controller and said input signal of said mi-com main controller;
an auxiliary remote controller for transmitting a remote signal;
a mi-com auxiliary controller for controlling an input signal thereof and said remote signal of said auxiliary remote controller;
an auxiliary graphic LCD device for graphically displaying a luminous intensity and a color temperature controlled by said mi-com auxiliary controller;
an auxiliary power supplier including a relay for supplying a D.C. power to said mi-com auxiliary controller and turning on or off an A.C. power supply under the control of said mi-com auxiliary controller; and
a plurality of auxiliary illuminators for illuminating at said luminous intensity and color temperature controlled by said remote signal of said auxiliary remote controller and said input signal of said mi-com auxiliary controller.

2. The lighting system of claim 1, wherein said mi-com main controller is able to easily control data throughout 24 hours by setting required data on a necessary point of time at specific intervals, and confirm overall 24-hour reservations at one sight by using said graphic LCD device.

3. The lighting system of claim 1, wherein said auxiliary illuminators connected to said mi-com auxiliary controller which is connected to said mi-com main controller in RS232C communication manner are controlled to be turned on or off at said specific luminous intensity and color temperature, and interlocked to the operation of said main controller so as to be simultaneously turned on or off.

4. The lighting system of claim 1, wherein if a user sets a reserved time and a sunrise period, said mi-com main controller controls said lighting system turned on at minimum luminous intensity and color temperature values before said pre-set time, said luminous intensity and color temperature values increasing by specific steps for said pre-set period and corresponding to the luminous intensity and color temperature of the sunrise time at the end of said pre-set period, later keeping final values.

5. The lighting system of claim 1, wherein if said user sets a reserved time and a sunset period, said mi-com main controller controls said lighting system turned on before said pre-set time, said luminous intensity and color temperature values decreasing by specific steps for said pre-set period and the power supply to said lighting system turned off at the end of said pre-set period, later keeping final values.

6. The lighting system of claim 1, wherein said mi-com main controller controls said lighting system to illuminate at said pre-set luminous intensity and color temperature, which may be re-set at said user's request.

7. The lighting system of claim 1, wherein if said user inputs a function key for producing a sunset effect in a one-touch manner, said mi-com main controller controls current luminous intensity and color temperature turned into initial luminous intensity and color temperature values in several seconds, said initial luminous intensity and color-temperature values decreasing by specific steps for a predetermined period of time and then keeping said final values when said power supply to said lighting system is turned off at the end of said pre-set period,

8. The lighting system of claim 1, wherein said mi-com main controller can lock said on-off action of said power supply, and said luminous intensity and color temperature by selecting either said main controller or said auxiliary controller connected to said main controller, and cancel said lock condition by letting said auxiliary controller request said main controller for said lock cancellation by inputting a specific key on said auxiliary controller, which is capable of self-setting later.

9. The lighting system of claim 1, wherein said mi-com main controller displays a variable range of said luminous intensity and color temperature and also the current state within a pre-displayed range when said user inputs a pertinent operation key disposed in said remote controller or in said mi-com main controller on said graphic LCD device, to set an illumination state desired by said user in a faster way.

10. The lighting system of claim 1, wherein said mi-com main controller pre-heats filaments of said illuminators by applying voltage to the filaments before said power-on of said illuminators to allow said illumination to be smoothly variable at a low luminous intensity when said user sets said reserved time and sunset period.

11. The lighting system of claim 1, wherein said mi-com main controller controls said luminous intensity and color temperature values to go up and down at a specific cycle repeatedly but to perform a sort of wave function where said values have a pause at the lowest point and at the highest point for several seconds.
